(19) United States
(12) Patent Application Publication
(10) Pub. No.: US 2007/0273731 A1
(43) Pub. Date: Nov. 29, 2007

(54) Method for driving an ink jet head having piezoelectric actuator

(75) Inventors: Whu-Ming Young, Palo Alto, CA (US); Yao-Hung Yang, Palo Alto, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF Technology Limited, Santa Clara, CA (US)

(21) Appl. No.: 11/442,407

(22) Filed: May 26, 2006

(51) Int. Cl. B41J 2/045

(52) U.S. Cl. 347/68

(57) ABSTRACT

A method for driving an ink jet head (10) having a piezoelectric actuator (103) includes the steps of: (a) transmitting a negative electrical pulse (31) to drive the piezoelectric actuator to transform in a manner such that ink is filled into an ink chamber (102) of the ink jet head; and (b) transmitting a positive electrical pulse (32) to drive the piezoelectric actuator to transform in a manner such that the ink is ejected out of the ink chamber.

### TECHNICAL FIELD

The present invention relates to methods for driving an ink jet head, and particularly to a method for driving an ink jet head having a piezoelectric actuator.

### BACKGROUND

Piezoelectric actuators are utilized for a variety of purposes. A piezoelectric actuator has electrodes formed at a top surface and a bottom surface of a layer (a piezoelectric layer) formed from a material that deforms when voltage is applied between the electrodes at the top surface and the bottom surface of the material. The shape of the piezoelectric layer can be changed by controlling the potential applied between the electrodes on the top surface and the bottom surface. Dividing at least one of the electrodes into a plurality of independent electrodes makes it possible to control the difference in potential applied to each part of the piezoelectric layer. One of the purposes of piezoelectric actuators is to drive an ink jet head used in an ink droplet generator, such as that used in an ink jet printer.

An ink jet head is used to fire/eject ink. A conventional ink jet head has a plurality of channels and the piezoelectric actuator. Each of the channels is allocated a nozzle. By activation of the piezoelectric actuator, a droplet of ink can be expelled from the selected nozzle.

Currently droplet properties in ink jets are controlled mainly by using jetting voltage. However, in a jet head with hundreds of nozzles, changing firing voltage for each nozzle is a technical challenge.

To simplify the design, a trapezoid voltage waveform with uni-polar voltage is used. However, even with this the control relationship between voltage and droplet properties is not necessary linear over the operating range.

What is needed, therefore is to provide a method for driving an ink jet head having a piezoelectric actuator that is easy to control.

### SUMMARY

A method for driving an ink jet head having a piezoelectric actuator provided herein generally includes the steps of:

(a) transmitting a negative electrical pulse to drive the piezoelectric actuator to transform in a manner such that ink is filled into an ink chamber of the ink jet head; and

(b) transmitting a positive electrical pulse to drive the piezoelectric actuator to transform in a manner such that the ink is ejected out of the ink chamber.

These and other features, aspects, and advantages of the present method will become more apparent from the following detailed description and claims, and the accompanying drawings.

### BRIEF DESCRIPTION OF THE DRAWINGS

Many aspects of the present method for driving an ink jet head having a piezoelectric actuator can be better understood with reference to the following drawings. The components in the drawings are not necessarily drawn to scale, the emphasis instead being placed upon clearly illustrating the principles of the present method. Moreover, in the drawings, like reference numerals designate corresponding parts throughout the several views.

FIG. 1 is a schematic, sectional view of a part of an ink droplet generator having an ink jet head in accordance with one embodiment, the ink jet head including a piezoelectric actuator;

FIG. 2 is a schematic waveform diagram for illustrating an electrical pulse in accordance with the embodiment;

FIG. 3 is a schematic, sectional view of an ink-filling state of the ink jet head in accordance with the embodiment;

FIG. 4 is a schematic, sectional view of an ink-firing state of the ink jet head in accordance with the embodiment;

FIG. 5 is a schematic waveform diagram for illustrating an electrical pulse in accordance with a first example of the embodiment;

FIG. 6 is a diagram of a curve showing dot mass verses duration in microseconds of the electrical pulse of FIG. 5;

FIG. 7 is a schematic waveform diagram for illustrating an electrical pulse in accordance with a second example of the embodiment;

FIG. 8 is a diagram of a curve showing dot mass verses duration in microseconds of the electrical pulse of FIG. 7;

FIG. 9 is a schematic waveform diagram for illustrating an electrical pulse in accordance with a third example of the embodiment; and

FIG. 10 is a diagram of a curve showing dot mass verses duration in microseconds of the electrical pulse of FIG. 9.

### DETAILED DESCRIPTION OF THE PREFERRED EMBODIMENTS

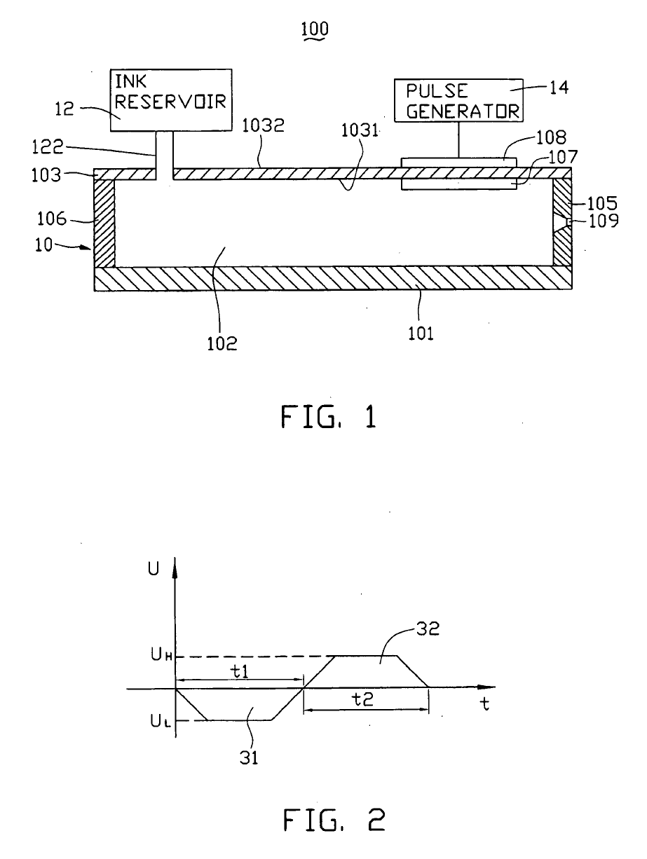

Referring to FIGS. 1 to 3, a part of an ink droplet generator 100 is shown. The ink droplet generator 100 includes an ink jet head 10, an ink reservoir 12 for supplying ink to the ink jet head 10, and a pulse generator 14 for controlling the ink jet head 10.

Referring to FIG. 1, the ink jet head 10 includes a base plate 101, a piezoelectric actuator 103 opposite to the base plate 101, a jet plate 105 and a plurality of side plates 106 connected between the base plate 101 and the piezoelectric actuator 103. The piezoelectric actuator 103 is in a form of a plate. The base plate 101, the piezoelectric actuator 103, the jet plate 105 and the side plates 106 cooperative define an ink chamber 102 for receiving ink therein. The jet plate 105 serves as a side wall of the ink chamber 102. The jet plate 105 has a nozzle 109 defined therein for ejecting/firing the ink through the nozzle 109. Alternatively, the base plate 101 and the side plates 106 could be integrally formed.

The piezoelectric actuator 103 is made of piezoelectric material, such as piezo-ceramic, and other suitable piezoelectric materials. Generally, the piezoelectric actuator 103 could be stacked or attached onto the ink chamber walls. The piezoelectric actuator 103 has an interior surface 1031, and an exterior surface 1032 opposite to the interior surface 1031. A pair of electrodes 107, 108 is arranged on the interior and exterior surfaces 1031, 1032, respectively. A pulse generator 14 electrically connects with the pair of electrodes 107, 108 for applying a voltage to the electrodes 107, 108. In operation, the pulse generator 14 applies a voltage to the electrodes 107, 108, a shearing force acting on the piezoelectric actuator 103 is produced due to the polarization direction of the piezoelectric material. Hence, the piezoelectric actuator 103 becomes deformed. When the piezoelectric actuator 103 is deformed towards the ink chamber 102 pressure acts on the ink in the ink chamber 103, and as a result an ink droplet may be ejected out via the nozzle 109.

Furthermore, the piezoelectric actuator 103 is connected to an ink reservoir 12 via a connection pipe 122. The ink chamber 102 can be filled and/or refilled with the ink supplied from the ink reservoir 12.

Referring to FIGS. 2 to 4, in order to simplified the description of the present embodiment of the method for driving the ink jet head 10 having a piezoelectric actuator 103, a single exemplary ink ejection cycle is described as follows. The method comprises the steps of:

Step (a): transmitting a negative electrical pulse 31 to drive the piezoelectric actuator 103 to transform in a manner such that ink is filled into the ink chamber 102 of the ink jet head 10, and

Step (b): transmitting a positive electrical pulse 32 to drive the piezoelectric actuator to transform in a manner such that the ink is ejected out of the ink chamber 102.

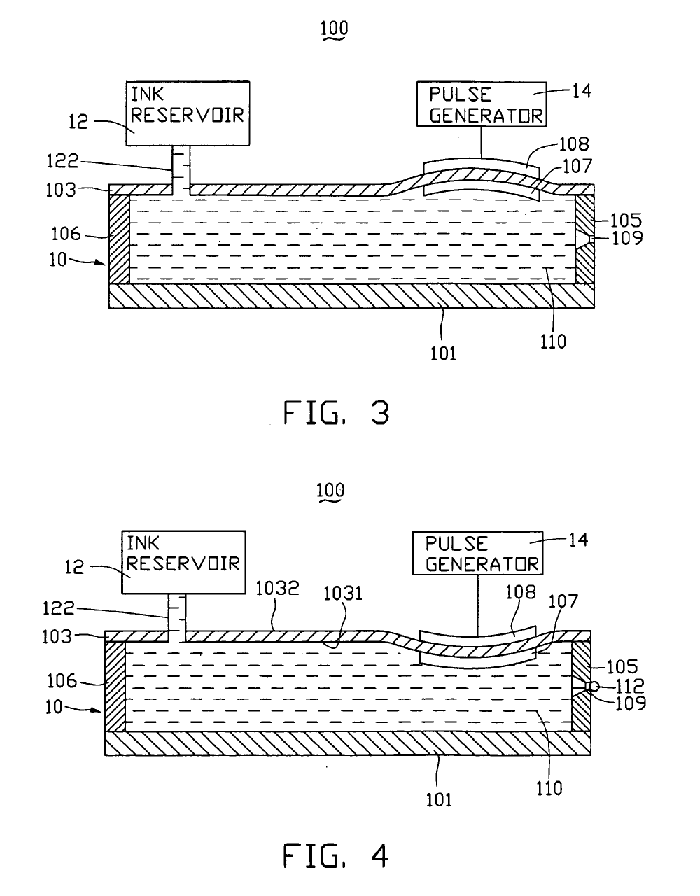

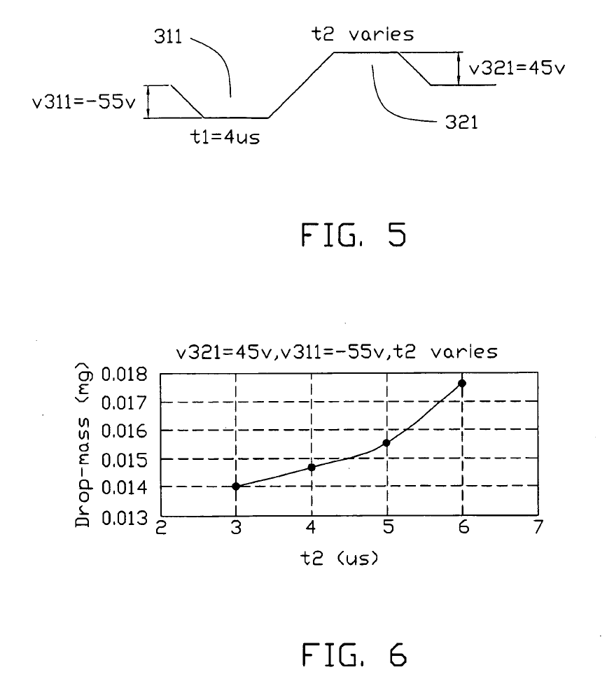

Referring to FIGS. 2 and 3, in step (a) the ink chamber 102 is filled with the ink from the ink reservoir 12. The pulse generator 14 applies a negative electrical pulse 31 to the pair of electrodes 107, 108. The piezoelectric actuator 103 is thereby deformed outwardly as shown in FIG. 3, a volume of the ink chamber 102 is thus increased. As a result, the ink 110 is introduced/sucked into the ink chamber 102 from the ink reservoir 12 until the ink chamber 102 is fully filled.

The negative electrical pulse 31 has a lower limit value in a range from −85 volts to −70 volts, and has a higher limit value in a range from −50 volts to −40 volts. Preferably, the negative electrical pulse 31 has a peak amplitude UL in a range from about −80 volts to about −48 volts.

The negative electrical pulse 31 has a first controlled duration t1 for rapidly and fully filling the ink chamber 102. The variation of the first controlled duration t1 may affect the volume of the ink 110 filled into the ink chamber 102, and even results in a change of a size of an ink droplet 112 expelled out of the ink chamber 102 in step (b). Preferably, the first controlled duration t1 is in a range from 2 microseconds to 6 microseconds.

Referring to FIGS. 2 and 4, in step (b) an ink droplet 112 is ejected out of the ink chamber 102. The pulse generator 14 applies a positive electrical pulse 32 to the pair of electrodes 107, 108. The piezoelectric actuator 103 is thereby deformed inwardly as shown in FIG. 4, thus decreasing the volume of the ink chamber 102. As a result, an ink droplet 112 is ejected out of the ink chamber 102 via the nozzle 109.

The positive electrical pulse 32 has a lower limit ranging from +35 volts to +55 volts, and has a higher limit ranging from +75 volts to +85 volts. Preferably, the positive electrical pulse 32 has a peak amplitude UH in a range from about +45 volts to about +80 volts.

The positive electrical pulse 32 has a second controlled duration t2 for precisely ejecting the ink droplet 112. It should be noted that the size of the ink droplet 112 could be adjusted by changing the second controlled time duration t2. It is preferable that the second controlled duration is in a range from 2 microseconds to 9 microseconds.

Furthermore, each of the negative pulse and the positive pulse could have a trapezoid shape, a rectangular shape, or other suitable shape. In the illustrated embodiment, the negative pulse and the positive pulse both have trapezoid shape (i.e. a sharp rise, a plateau and then a sharp fall) because it is beneficial to provide the ink jet head 10 a short period of time as a buffer to adjust itself to the next action.

Understandably, the step (a) and (b) could be repeated in order to refill the ink chamber 102 and expel more ink droplets 112 out from the ink chamber 102. Steps (a) and (b) are preferably performed under a temperature in a range from 70 degree centigrade to 75 degree centigrade.

In the present embodiment, the pulse generator 14 is, for example, an arbitrary waveform generator. The ink droplet generator 100 may have an FPGA (field programmable gate array) board to precisely control the operation of the pulse generator 14 and the ink jet head 10. The ink jet head 10 can be a spectra piezo-based SX printhead. The ink droplet generator 100 is used to fabricate RGB arrays of color filters. Alternatively, the ink droplet generator 100 could be an ink jet printer or the like.

In the present embodiment, the drop size/mass can be effectively controlled by altering the second controlled duration t2 under fixed negative and positive electrical pulses 31, 32, and the first controlled duration t1. The relationship between the second controlled duration t2 and drop mass is approximately linear, therefore, the droplet size can be readily controlled with high precision.

### EXAMPLE 1

Referring to FIGS. 5 and 6, in this example, a negative electrical pulse 311 and a positive electrical pulse 321, as shown in FIG. 5, are alternately applied to the ink jet head 10. The negative electrical pulse 311 has a peak amplitude of −55 volts. The positive electrical pulse 321 has a peak amplitude of +45 volts. The first controlled duration t1 of the negative electrical pulse 311 is fixed to be 4 microseconds. The second controlled duration t2 of the positive electrical pulse 321 varies from 3 microseconds to 6 microseconds. A variation of the corresponding drop-mass is shown in FIG. 6.

### EXAMPLE 2

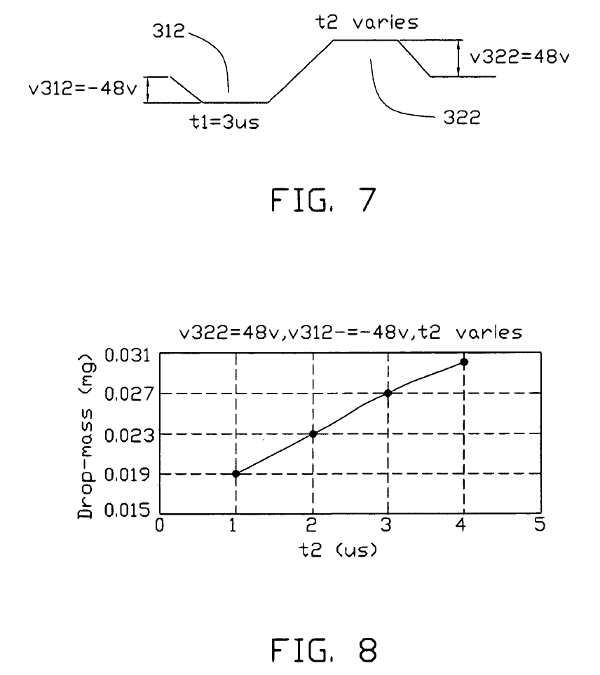

Referring to FIGS. 7 and 8, in this example, a negative electrical pulse 312 and a positive electrical pulse 322, as shown in FIG. 7 are alternately applied to the ink jet head 10. The negative electrical pulse 312 has a peak amplitude of −48 volts. The positive electrical pulse 322 has a peak amplitude of +48 volts. The first controlled duration t1 of the negative electrical pulse 312 is fixed to be 3 microseconds. The second controlled duration t2 of the positive electrical pulse 322 varies from 1 microsecond to 4 microseconds. A variation of the corresponding drop-mass is shown in FIG. 8. The relationship between the second controlled duration t2 and the drop-mass is linear.

### EXAMPLE 3

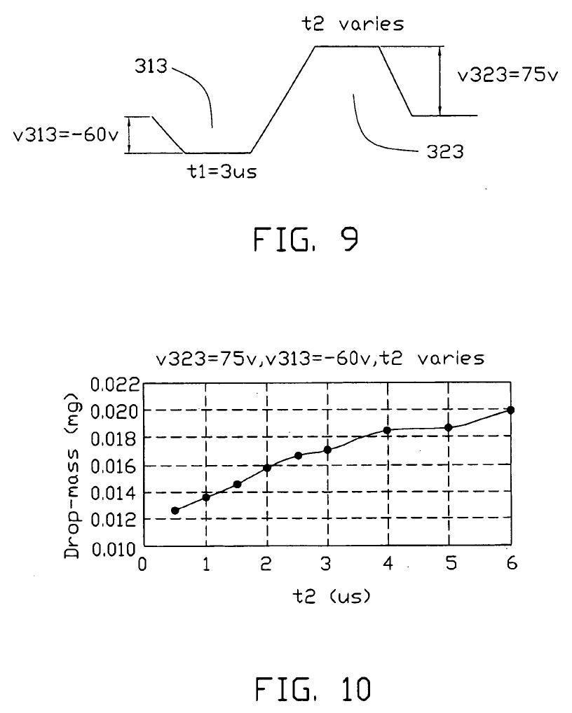

Referring to FIGS. 9 and 10, in this example, a negative electrical pulse 313 and a positive electrical pulse 323, as shown in FIG. 9 are alternately applied to the ink jet head 10. The negative electrical pulse 313 has a peak amplitude of −60 volts. The positive electrical pulse 323 has a peak amplitude of +75 volts. Therein, the first controlled duration t1 of the negative electrical pulse 313 is fixed to be 3 microseconds. The second controlled duration t2 of the positive electrical pulse 322 varies from 0.5 microseconds to 6 microseconds. A variation of the corresponding drop-mass is shown in FIG. 10.

It should be noted that the above-described ink droplet generator 100 has been provided for the purposes of illustrating the present invention. Said ink droplet generator 100 is not critical to practicing the present invention. A variety of conventional ink droplet generators are known to those skilled in the art, and may be suitably adapted for practicing the present invention. In particular, the piezoelectric ink jet head 10 are exemplified herein for illustration purposes only, and are not intended to limit the present invention.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A method for driving an ink jet head having a piezoelectric actuator, the method comprising the steps of:
transmitting a negative electrical pulse to drive the piezoelectric actuator to transform in a manner such that ink is filled into an ink chamber of the ink jet head; and
transmitting a positive electrical pulse to drive the piezoelectric actuator to transform in a manner such that the ink is ejected out of the ink chamber.

2. The method according to claim 1, wherein the negative electrical pulse has a peak amplitude in a range from about −80 volts to about −48 volts.

3. The method according to claim 1, wherein the positive electrical pulse has a peak amplitude in a range from about 45 volts to about 80 volts.

4. The method according to claim 1, wherein the negative electrical pulse is about −48 volts, the positive electrical pulse is about 48 volts.

5. The method according to claim 1, wherein the negative electrical pulse has a first controlled duration configured for rapidly and fully filling the ink into the ink chamber.

6. The method according to claim 5, wherein the first controlled duration is in a range from 2 microseconds to 6 microseconds.

7. The method according to claim 1, wherein the positive electrical pulse has a second controlled duration configured for precisely ejecting the ink.

8. The method according to claim 7, wherein the second controlled duration is in a range from 2 microseconds to 9 microseconds.

9. The method according to claim 1, wherein the negative pulse has a trapezoid shape.

10. The method according to claim 1, wherein the positive pulse has a trapezoid shape.

11. The method according to claim 1, wherein step (a) and (b) are performed under a temperature in a range from 70 degree centigrade to 75 degree centigrade.
